(19) United States
(12) Patent Application Publication
(10) Pub. No.: US 2011/0242980 A1
(43) Pub. Date: Oct. 6, 2011

(54) Capacity Monitoring of Multi-Service Networks

(75) Inventor: Attila Bader, Paty (HU)

(73) Assignee: TELEFONAKTIEBOLAGET LM ERICSSON (PUBL), Stockholm (SE)

(21) Appl. No.: 13/139,024

(22) PCT Filed: Dec. 12, 2008
(86) PCT No.: PCT/SE2008/051448

§ 371 Date: Jun. 10, 2011

(51) Int. Cl. H04W 28/10

(52) U.S. Cl. 370/235

(57) ABSTRACT

A network management device (140) coupled to a multi-service transport network (130) includes a network performance monitoring unit (400) configured to monitor a number of active calls, throughput, and call blocking data associated with each service of multiple services service by a multi-service transport network (130), where each service of the multiple services serviced by the multi-service transport network (130) is associated with a different one of multiple traffic types. The network management device (140) further includes a network capacity analyzer (420) configured to: estimate a transport capacity of the multi-service transport network (130), for use in network capacity planning, based on the number of active calls, the throughput, the call blocking data, and quality of service, QoS, and grade of service, GoS, requirements associated with each of the multiple services.

### TECHNICAL FIELD

Implementations described herein relate generally to multi-service networks and, more particularly, to capacity monitoring of multi-service networks.

### BACKGROUND

Multi-service transport networks, such as third generation (3G) Wideband Code Division Multiple Access (WCDMA) networks and Long Term Evolution (LTE) Radio Access Networks (RANs), handle multiple different service types that each have different Quality of Service (QoS) and Grade of Service (GoS) requirements. Multi-service transport networks typically transport the different service types at the same time using the same network resources. QoS parameters, such as delay and loss requirements, characterize the transport at a packet level. GoS requirements characterize the offered service levels at the call level. A Call Admission Control (CAC) function may be used to ensure QoS for admitted packet flows. Before a new call is established, the CAC function checks if there are adequate available network resources to support the required QoS for the new call in addition to that of already active calls. Call arrival is generally a statistical process where the number of active calls has a certain statistical fluctuation and the offered traffic for a given link capacity and blocking target (e.g., GoS target) is less than a maximum capacity of a given link. In most practical cases, call arrival is well described by a Poisson process.

The designing of a transport network typically includes the use of a detailed dimensioning process. The dimensioning process assumes a certain transport network configuration and an estimated busy hour traffic mix and load, and requires the QoS and GoS targets for each service as an input to the dimensioning process. The output of the dimensioning process is the dimensioned (i.e., planned) link capacity for each interface. The initial dimensioning process is an off-line process that is based on a hypothetical traffic model and load. In the case of introducing new services, substantial traffic changes, or network expansion, the network may be re-dimensioned and reconfigured. The role of dimensioning is typically to plan the transport network capacity for a long time period, such as, for example, a year.

### SUMMARY

Exemplary embodiments described herein may provide a network management node that supervises network operations and includes a network performance measurement capability that measures network parameters and records the occurrences of specific network events. The measured network parameters may be collected over a certain period of time and stored in a database for use in estimating a required transport capacity value that may be used in visualizing and planning a capacity of a multi-service transport network. An exemplary process described herein may estimate a transport capacity for the multi-service network which may then be compared with planned dimensioned capacities and maximum physical capacities. Additionally, the actual blocking rates of the CAC'd traffic types may be compared with GoS requirements for the corresponding service types. The exemplary process described herein may take into account the QoS and GoS target requirements when the required transport capacity is estimated based on the measured traffic load.

According to one aspect, a method implemented in a network management node associated with a multi-service transport network (130) may include obtaining dimensioned network parameters associated with an initial plan of a multi-service transport network and measuring performance parameters associated with each service of multiple services of the multi-service transport network, where each service may be associated with a different one of multiple traffic types. The method may further include estimating a transport capacity for the multi-service transport network based on the measured performance parameters, based on the obtained dimensioned network parameters, and based on quality of service (QoS) and grade of service (GoS) requirements associated with each of the different traffic types and providing the estimated transport capacity for network capacity planning.

According to a further aspect, a network management device coupled to a multi-service transport network may include a network performance monitoring unit configured to: monitor a number of active calls, throughput, and call blocking data associated with each service of multiple services serviced by the multi-service transport network, where each service of the multiple services serviced by the multi-service transport network is associated with a different one of multiple traffic types. The network management device may further include a network capacity analyzer configured to: estimate a transport capacity of the multi-service transport network, for use in network capacity planning, based on the number of active calls, monitored throughput and call blocking data and based on quality of service (QoS) and grade of service (GoS) requirements associated with each of the multiple services.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIGS. 1A and 1B illustrate exemplary environments in which user equipment may communicate with devices via a network(s) that includes a multi-service transport network;

FIG. 2 depicts a network management node, coupled to the multi-service transport network of FIGS. 1A and 1B, for obtaining network performance parameters associated with multiple service types serviced by the multi-service transport network;

FIG. 3 is a diagram that illustrates exemplary components of the network management node of FIGS. 1A, 1B and 2;

FIG. 4 is a diagram that illustrates exemplary functional components of the network management node of FIG. 3;

FIG. 5 is a flowchart that illustrates an exemplary process for estimating a network capacity based on measured network performance parameters, dimensioned parameters, and QoS and GoS requirements;

FIG. 6 is a flowchart that illustrates exemplary details of the network capacity estimation of FIG. 5;

FIG. 7 is a flowchart that illustrates exemplary details of the provision of the network capacity estimation for network capacity and visualization of FIG. 5; and

FIGS. 8A, 8B and 9 illustrate examples of the provision of the estimated network capacity values for network capacity visualization and planning.

### DETAILED DESCRIPTION

The following detailed description of the invention refers to the accompanying drawings. The same reference numbers in different drawings may identify the same or similar elements. Also, the following detailed description does not limit the invention.

“RABs,” as referred to herein, may include radio access bearers (RABs) that carry traffic (e.g., in 3G WCMA and/or LTE RAN transport networks). The different services of multi-service transport networks may be mapped onto different RABs. RABs may be characterized by fixed physical parameters, such as, for example, a Transmission Time Interval (TTI), a packet size, and a bit rate. Each service in 3G WCMA and LTE RAN may include certain QoS requirements (e.g., maximum packet loss and packet delay) that can be derived from system requirements. Delay sensitive traffic (e.g., voice traffic) can be the subject of Call Admission Control (CAC). Before the establishment of each RAB, CAC may check if the available link capacity is large enough for ensuring the QoS for the active and new call. If the capacity is not enough, the call may be blocked. The network operator may determine the GoS requirements for each RAB (e.g., an allowed call blocking ratio). Packet Switched data may usually not be CAC'd, but may be delivered as best effort (BE) traffic which is scheduled in lower priority queues. BE traffic may usually be admitted, but QoS may be ensured by appropriate network dimensioning. CAC'd and BE traffic are transported in the same network and they share the same transport resources.

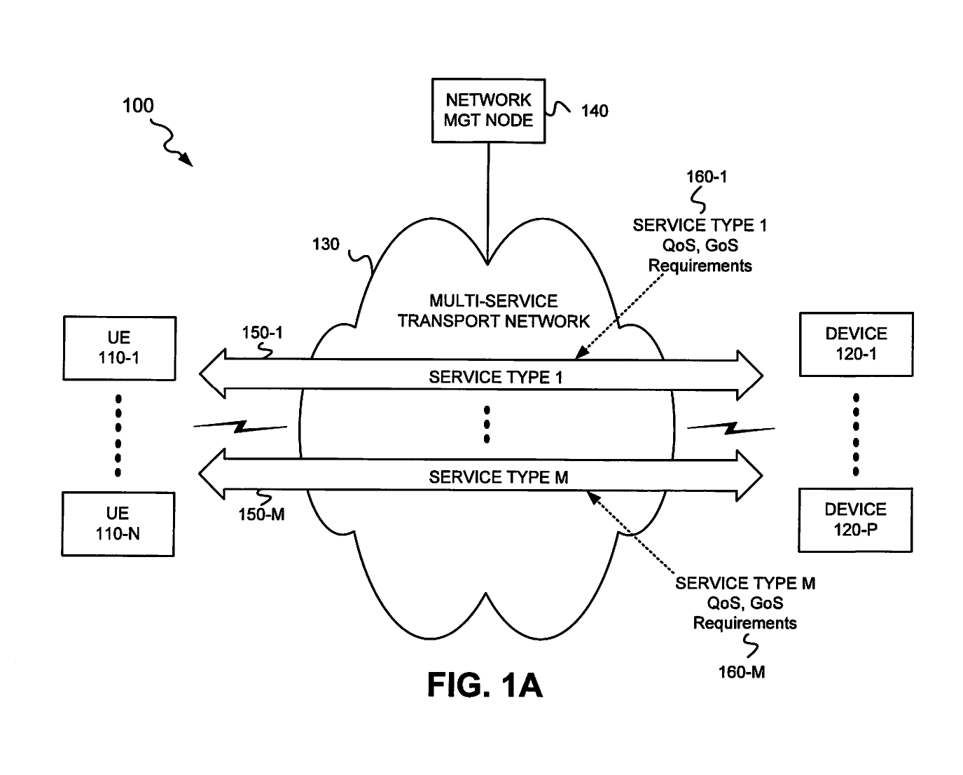

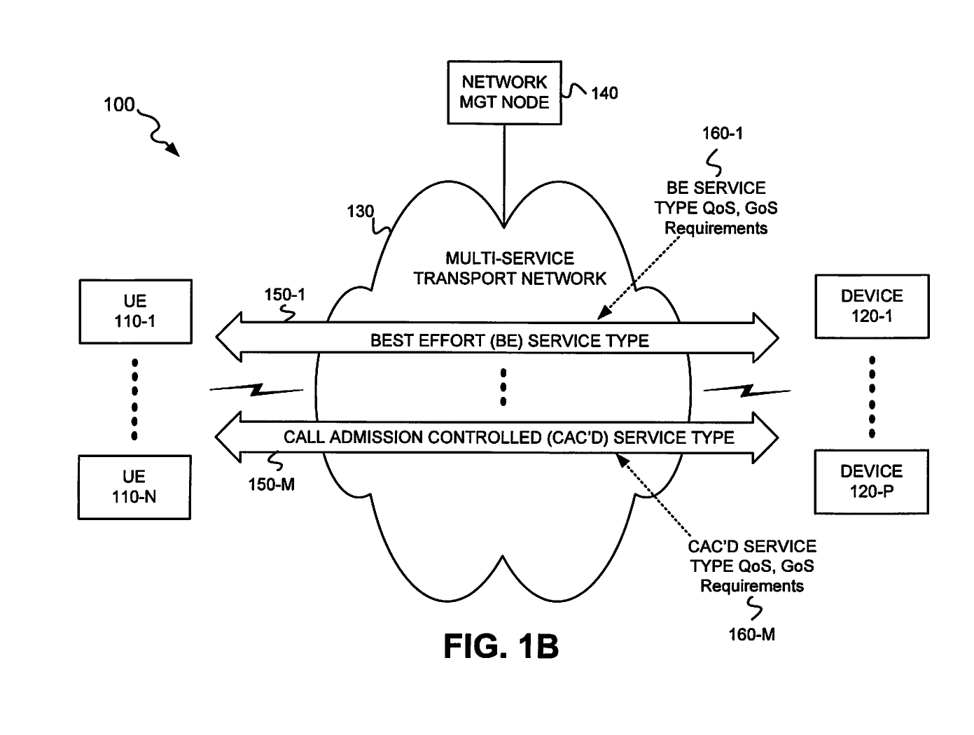

FIG. 1A illustrates an exemplary environment 100 of user equipment that may communicate with devices via a network(s) that may includes a multi-service transport network. As shown in FIG. 1A, environment 100 may include multiple UEs 110-1 through 110-N that may communicate with one or more devices 120-1 through 120-P via multiple service types 150-1 through 150-M that are serviced or supported by a multi-service transport network 130. Multi-service transport network 130 may include any type of transport network that services multiple different network service types. Multi-service transport network 130 may include, for example, a 3G WCDMA and/or LTE RAN. Each of the service types serviced by multi-service transport network 130 may have associated QoS and GoS requirements. For example, as shown in FIG. 1A, service type 1 150-1 may be associated with service type 1 QoS and GoS requirements 160-1, and service type M may be associated with service type 2 QoS and GoS requirements 160-M.

UEs 110-1 through 110-N may each include a cellular radiotelephone, a personal digital assistant (PDA), a Personal Communications System (PCS) terminal, a laptop computer, a palmtop computer, or any other type of device or appliance that includes a communication transceiver that permits the device to communicate with other devices via multi-service transport network 130. UEs 110-1 through 110-N may be referred to individually herein as “UE 110.” A PCS terminal may combine a cellular radiotelephone with data processing, facsimile and data communications capabilities. A PDA may include a radiotelephone, a pager, an Internet/intranet access device, a web browser, an organizer, calendars and/or a global positioning system (GPS) receiver.

Devices 120-1 through 120-P may include devices similar device to UEs 110-1 through 110-N and, in some implementations, may additionally include a telephone (e.g., Plain Old Telephone system (POTs) telephones) that is connected to a Public Switched Telephone Network (PSTN).

FIG. 1B depicts an exemplary implementation in which multi-service transport network 130 services, possibly among other services, may include a best effort (BE) service type 150-1 and a call admission controlled (CAC'd) service type 150-M. BE service type 150-1 may include a service type that does not require guarantees of network access. CAC'd service type 150-M may include a service type in which a CAC function may be used to ensure QoS for admitted data flows. The CAC function may ensure that, before a new call is established, there are adequate available network resources to support the required QoS for the new call in addition to that of any already active calls. As further shown in FIG. 1B, BE service type 150-1 may be associated with BE service type QoS and GoS requirements 160-1 and CAC'd service type 150-M may be associated with CAC'd service type QoS and GoS requirements 160-M.

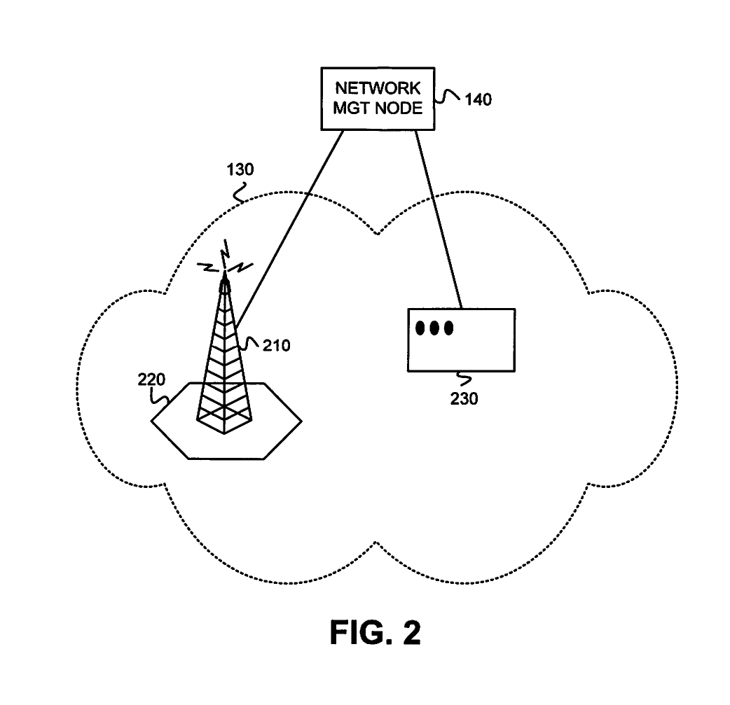

FIG. 2 depicts network management node 140, coupled to multi-service transport network 130 of FIGS. 1A and 1B, so that network management node 140 may obtain network performance parameters associated with multiple service types serviced by multi-service transport network 130. FIG. 2 depicts simplified details of transport network 130 in which a single base station 210 supporting a single cell 220 and a single network node 230 is shown by way of example. As shown, network management node 140 may be coupled to base station 210 and to network node 230 to obtain network performance parameters. Network management node 140 may be coupled to other network nodes (not shown) to obtain and/or measure other network performance parameters. Network management node 140 may be coupled to numerous other base stations and network nodes (not shown) for obtaining network performance parameters from those base stations and/or network nodes.

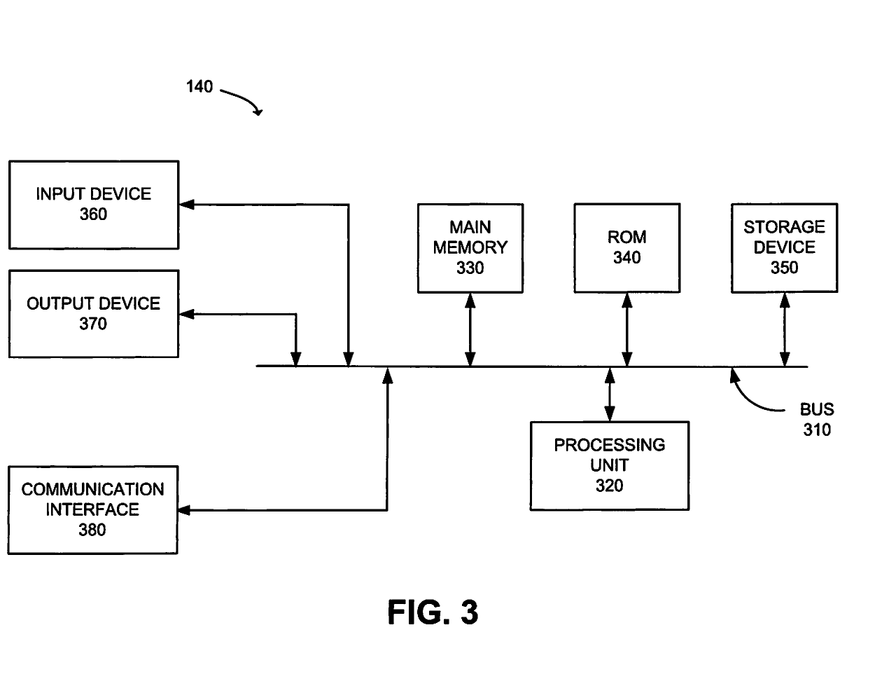

FIG. 3 is a diagram of network management node 140 according to an exemplary implementation. Network management node 140 may include a bus 310, a processing unit 320, a main memory 330, a read only memory (ROM) 340, a storage device 350, an input device 360, an output device 370, and a communication interface 380. Bus 310 may include a path that permits communication among the elements of network management node 140. Processing unit 320 may include one or more processors, microprocessors, or processing logic that may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium and its corresponding drive.

Input device 360 may include a mechanism that permits an operator to input information to network management node 140, such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables network management node 140 to communicate with other devices and/or systems. For example, communication interface 380 may include mechanisms for communicating with another device or system via a network, such as multi-service transport network 130.

Network management node 140 may perform certain operations or processes described herein. Network management node 140 may perform these operations in response to processing unit 320 executing software instructions contained in a computer-readable medium, such as main memory 330. A computer-readable medium may be defined as a physical or logical memory device. A logical memory device may include memory space within a single physical memory device or spread across multiple physical memory devices. Each of main memory 330, ROM 340 and storage device 350 may include computer-readable mediums. The magnetic and/or optical recording mediums (e.g., readable CDs or DVDs) of storage device 350 may also include computer-readable mediums.

The software instructions may be read into memory 330 from another computer-readable medium, such as storage device 350, or from another device via communication interface 380. The software instructions contained in main memory 330 may cause processing unit 320 to perform operations or processes described herein. Alternatively, hardwired circuitry may be used in place of or in combination with software instructions to implement processes described herein. Thus, embodiments described herein are not limited to any specific combination of hardware circuitry and software.

The configuration of components of network management node 140 illustrated in FIG. 3 is for illustrative purposes only. Other configurations with more or fewer components, or a different arrangement of components may be implemented.

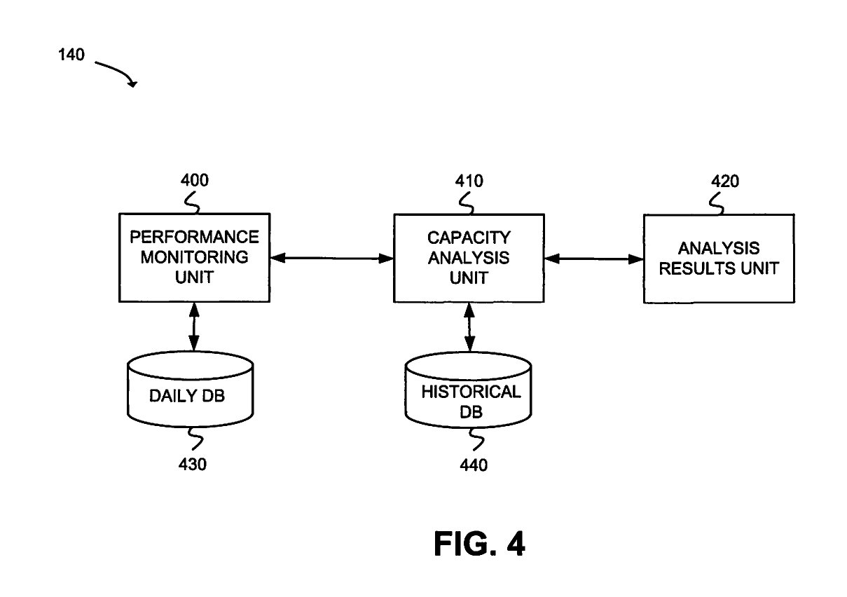

FIG. 4 is a diagram that illustrates exemplary functional components of network management node 140. The functional components of node 140 may include a performance monitoring unit 400, a capacity analysis unit 410, an analysis results unit 420, a daily database (DB) 430, and a historical DB 440.

Performance monitoring unit 400 may monitor and measure parameters associated with multi-service transport network 130. The monitored network performance parameters may include one or more of the following:

1) a sum of the measured throughput (e.g., in kilobytes per second (kbps)) for traffic that is delivered via best effort (BE_{Throughput});

2) a number of active calls for CAC'd traffic types;

3) a number of blocked calls for CAC'd RABs;

4) an equivalent bandwidth (equiv. BW) for each RAB. For services delivered via best effort, the transmission rate of the RAB multiplied by a RAB utilization factor can be used as the equivalent BW for the RAB; and/or

5) an active number of RABs aggregated for a given link. Performance monitoring unit 400 may measure the network parameters for certain sample periods (e.g., 1-5 minute periods) and may also sum or average the measured network parameters over a larger measurement period (e.g., 15-60 minutes). Performance monitoring unit 400 may store the measured network parameters in daily DB 430 for use by capacity analysis unit 410.

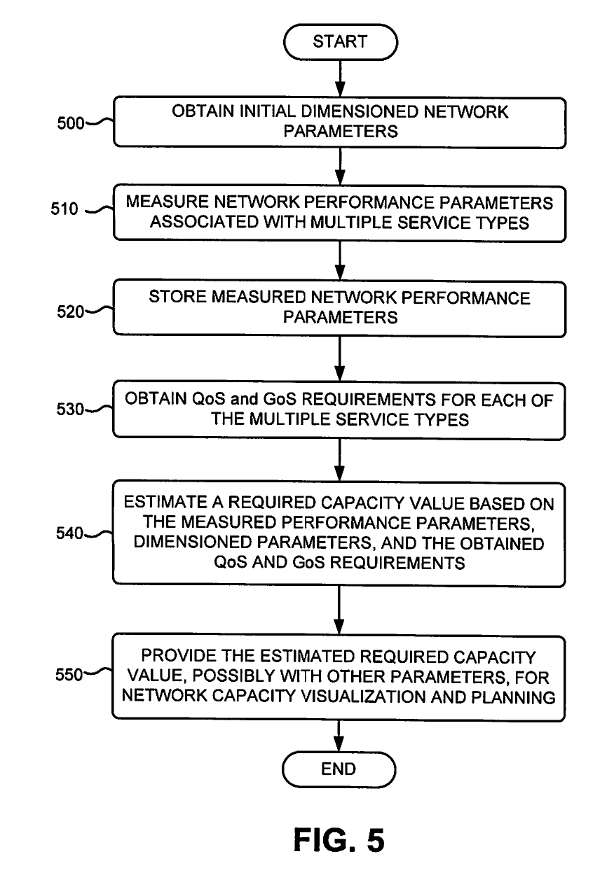

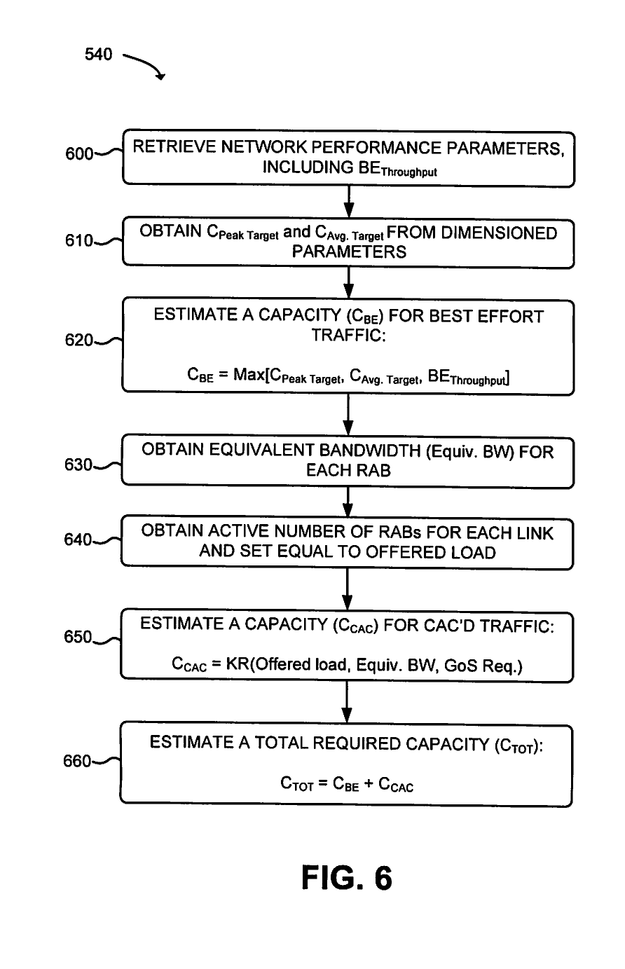

Capacity analysis unit 410 may estimate a required network capacity value for network 130 based on the network parameters measured by monitoring unit 400, and further based on parameters from an initial network dimensioning process and QoS and GoS requirements for each service type serviced by network 130. The network capacity estimation is described further below with respect to block 540 of FIG. 5, with details of a specific exemplary implementation described with respect to blocks 600 through 660 of FIG. 6. Capacity analysis unit 410 may store a historical record of the estimated network capacity value in historical DB 440.

Analysis results unit 420 may provide the estimated network capacity value, possibly with other parameters, for network capacity visualization and planning. For example, analysis results unit 420 may provide a graphical display that depicts the estimated network capacity value in conjunction with other parameters. The other parameters that may be provided (e.g., displayed) in conjunction with the estimated network capacity value may include dimensioned capacity values resulting from the initial dimensioning process for network 130, a maximum physical capacity of given link, and/or GoS targets for each RAB in network 130.

Daily DB 430 and historical DB 440 may be stored in a memory device associated with network management node (e.g., main memory 330).

FIG. 5 is a flowchart that illustrates an exemplary process for estimating a network capacity based on measured network performance parameters, dimensioned parameters, and QoS and GoS requirements. In some implementations, the exemplary process of FIG. 5 may be implemented by network management node 140. In other implementations, the exemplary process of FIG. 5 may be implemented by network management node 140 in conjunction with one or more other nodes of network 130. The exemplary process of FIG. 5 may be selectively repeated for each link of network 130 monitored by network management node 140.

The exemplary process may begin with obtaining initial dimensioned network parameters (block 600). Network dimensioning may include an off-line method for network capacity planning which may be based on a hypothetical traffic mix derived from marketing data. The role of network dimensioning may be to plan the transport network capacity for a period of time (e.g., one year). The dimensioned network parameters obtained from the network dimensioning process may include (but are not limited to) C_{Peak target} and C_{Aver.target}. C_{Peak target} may be determined from the network dimensioning process and may represent a peak capacity target value that the network operator attributes to a single user. C_{Aver.target} may be determined from the network dimensioning process and may represent an average capacity target value that the network operator attributes to a single user.

Network performance parameters associated with multiple different service types may be measured (block 510). For example, performance monitoring unit 400 may measure one or more network performance parameters associated with each of the multiple different service types. The measured network performance parameters may include a number of active calls (e.g., for CAC'd traffic types), the sum of the measured throughput (e.g., in kbps) for traffic that is delivered via best effort (BE_{Throughput}), a number of blocked calls for CAC'd RABs, an equivalent bandwidth (equiv. BW) for each RAB, and/or the measured offered load for each Radio Access Bearer (RAB), where the offered load equals an active number of RABs aggregated for a given link. The equivalent BW for a RAB can be a predetermined valued (e.g., retrieved from a table) or may be obtained from measurement, simulation, or calculation assuming a certain traffic model. The equivalent BW for a RAB may also be calculated dynamically from a CAC algorithm. For services delivered via best effort, the transmission rate of the RAB multiplied by a RAB utilization factor can be used as the equivalent BW for the RAB. Performance monitoring unit 400 may measure the network parameters for certain sample periods (e.g., 1-5 minute periods) and may also average the measured network parameters over a larger measurement period (e.g., 15-60 minutes).

The measured network performance parameters may be stored (block 520). For example, performance monitoring unit 400 may store the measured network performance parameters in daily DB 430 for retrieval and analysis by capacity analyzing unit 410.

QoS and GoS requirements for each of the multiple service types may be obtained (block 530). For example, the QoS requirements may include delay and packet loss requirements associated with each of the multiple different service types. Additionally, the GoS requirements may include a maximum allowed call blocking ratio for each RAB type. The QoS and GoS requirement values may be set by the network operator for maintaining service quality standards for each of the types of network services.

A required capacity value may be estimated based on the measured performance parameters, dimensioned parameters, and the obtained QoS and GoS requirements (block 540). Estimation of the required capacity value, as described in further detail below, may take into account the QoS and GoS requirements for each service type of the multiple different services offered by transport network 130. Estimation of the required capacity value may be performed by capacity analysis unit 410.

The flowchart of FIG. 6 illustrates details of the required capacity value estimation of block 540 according to one exemplary implementation. The estimation of the required capacity value may begin with retrieval of network performance parameters, including BE_{Throughput} (block 600). BE_{Throughput} may have been previously measured by performance monitoring unit 410 and stored in daily DB 430 for retrieval. C_{Peak Target} and C_{Avg.Target} may be obtained from the dimensioned parameters (block 610). A capacity (C_{BE}) for best effort traffic may be estimated (block 620). In one exemplary implementation, C_{BE} may be estimated in accordance with the following relation:

C_{BE}=Max[C_{Peak Target}, C_{Avg.Target}, BE_{Throughput}] Eqn. (1)

Thus, the estimated value for CBE may include the maximum value among C_{Peak Target}, C_{Avg.Target} and BE_{Throughput}.

An equivalent bandwidth (Equiv. BW) for each RAB may be obtained (block 630). As discussed above with respect to block 510, the equiv. BW for each RAB may have previously been retrieved from a table or calculated dynamically from a CAC algorithm. An active number of RABs for each link may be obtained and set equal to an offered load (block 640). For example, performance monitoring unit 400 may have previously determined the active number of RABs for each link in multi-service transport network 130.

A capacity (C_{CAC}) for CAC'd traffic may be estimated (block 650). In one exemplary implementation, C_{CAC} may be estimated in accordance with the following relation:

C_{CAC}=KR(Offered Load, Equiv. BW, GoS req.) Eqn. (2)

where “KR” may represent the known Kaufman-Roberts recursive algorithm that may be applied to the offered load, the equiv. BW, and the GoS requirement. The GoS requirement may be an input parameter determined by the network operator and, in one implementation, may include the maximum allowed call blocking ratio for each RAB.

A total required capacity (C_{Tot}) may be estimated (block 660). In one exemplary implementation, C_{Tot} may be estimated in accordance with the following relation:

C_{Tot}=C_{BE}+C_{CAC} Eqn. (3)

C_{Tot}, thus, may include the sum of the C_{BE} value, determined in block 620 above, and the C_{CAC} value, determined in block 650 above.

Returning to FIG. 5, the estimated required capacity value may be provided, possibly with other parameters, for network capacity visualization and planning (block 550). The results of required capacity value estimation performed by capacity analyzing unit 410 may be provided to analysis results unit 420. Analysis results unit 420 may, in turn, provide the estimated required capacity value possibly in conjunction with other parameters. For example, analysis results unit 420 may provide a visual display (e.g., via output device 370) of the estimated required capacity value. A network planner associated with the network operator may use the provided required capacity value for visualizing a capacity of network 130 and/or for network capacity planning.

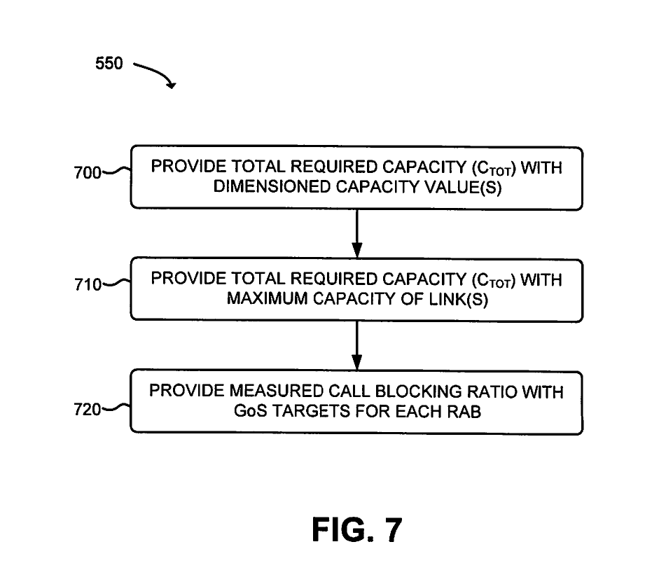

The flowchart of FIG. 7 illustrates details of the required capacity value estimation of block 550 according to one exemplary implementation. As shown, provision of the requirement capacity value may include providing the total required capacity (C_{Tot}) value along with dimensioned capacity value(s) (block 700). Large differences between C_{Tot} and dimensioned capacity values may indicate that the original traffic model used in the network dimensioning process was incorrect, or that the traffic mix and/or load changed significantly.

The total required capacity (C_{Tot}) value may be provided along with a maximum capacity of the link(s) (block 710). If a comparison of C_{Tot} with the maximum capacity indicates that C_{Tot} is higher than the maximum capacity of the link, then GoS or other target values will not be met. Further monitoring, therefore, may be warranted to determine if this is due to an exceptional event or whether link capacity update or reconfiguration may be necessary.

The measured call blocking ratio may be provided along with GoS targets for each RAB (block 720). The measured call blocking ratio may be compared with the GoS targets for each RAB to identify if the call blocking ratio is higher than the maximum allowed blocking ratio for each RAB.

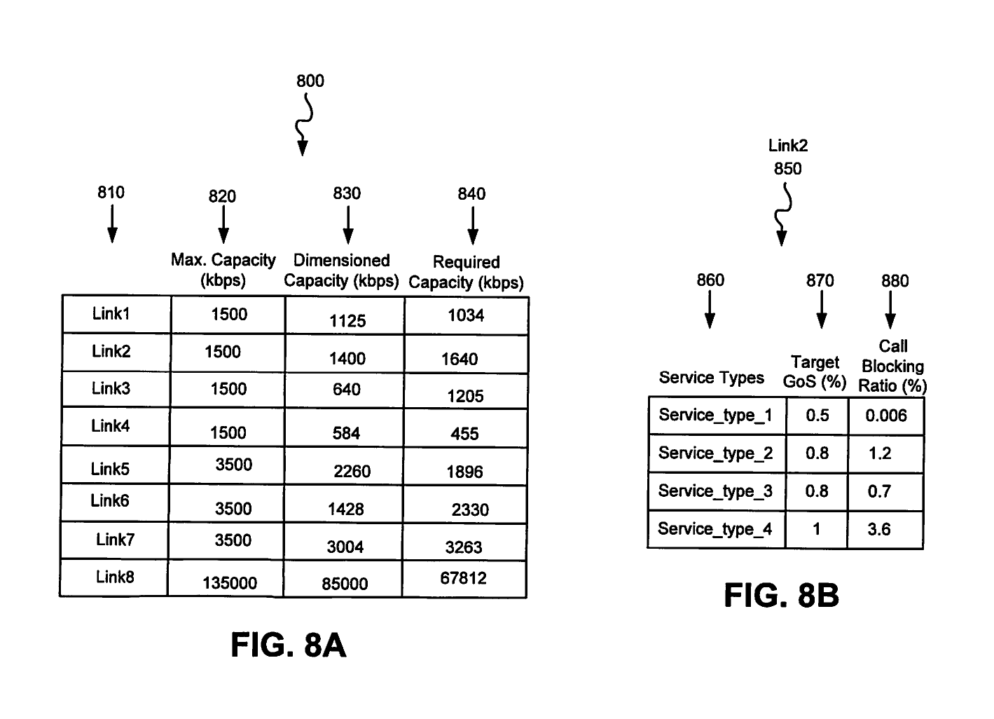

FIG. 8A depicts an example of a table 800 that may be provided by analysis results unit 420 based on the capacity values estimated by capacity analysis unit 410. As shown in the example of FIG. 8A, links 810 may be identified, and a maximum capacity value 820 (in kbps), a dimensioned capacity value 830 (in kbps), and an estimated required capacity value 840 (in kbps) may be provided for each identified link. Max. capacity value 820 may represent the actual maximum physical capacity for each link in kbps. Dimensioned capacity 830 may represent the planned capacity in kbps for each link that is obtained from the network dimensioning process. Required capacity value 840 may represent the required capacity value (in kbps) estimated by capacity analysis unit 410 for each link. For example, as shown in FIG. 8A, link 2 may have a max. capacity 820 of 1500 kbps, a dimensioned capacity 830 of 1400 kbps, and an estimated required capacity 840 of 1640 kbps.

As can be seen from the values contained in table 800, link 1, link 4, link 5 and link 8 are operating normally since the estimated required capacity is less than the dimensioned capacity and the estimated required capacity and the dimensioned capacity are less than the maximum capacity. However, link 2, link 3 and link 6 have estimated required capacity values that are larger than the dimensioned (planned) values. Link 7 also has an estimated required capacity value close to the maximum physical capacity of the link. Thus, it is apparent from table 800 that links 2, 3, 6 and 7 may require link capacity improvements to handle the current capacity demands on the links.

FIG. 8B further depicts an example of a table 850 associated with a given link (e.g., link 2) of table 800. Table 850 may identify different service types 860 serviced by the given link, and target GoS 870 and measured call blocking ratios 880 for each of the different service types. For example, as shown FIG. 8B, service type 1 may have a target GoS 870 of 0.5% and a measured call blocking ratio 880 of 0.006%. As is apparent from table 850, service types 2 and 4 may include measured call blocking ratios that exceed the maximum target GoS for those services.

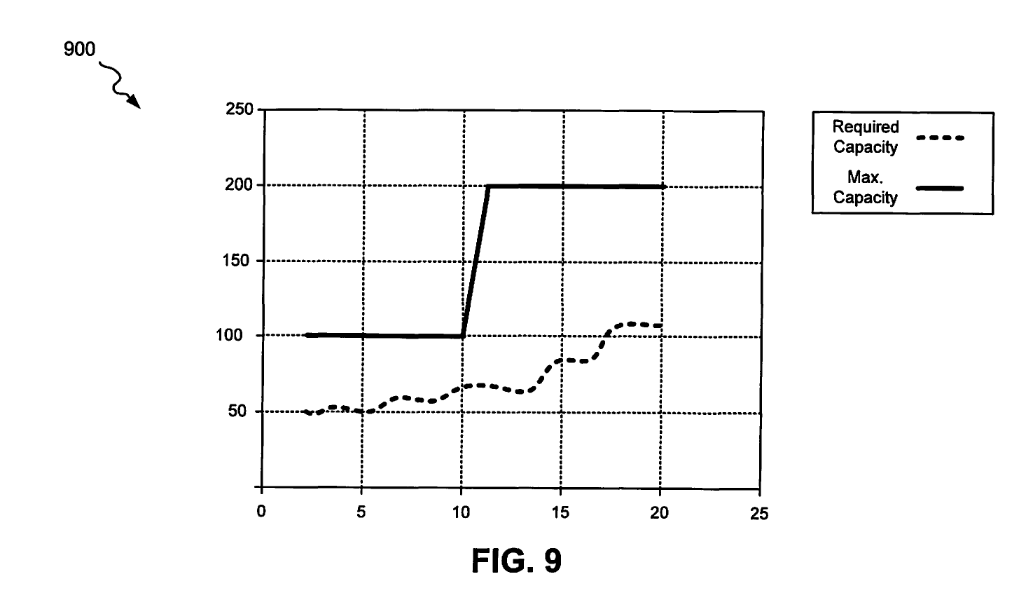

FIG. 9 illustrates a display 900 of a historical trend of an estimated required capacity in conjunction with the maximum physical capacity. Display 900 may permit trend analysis and capacity planning by comparing plots of historical values of estimated required capacities. As an example, when an estimated required capacity reaches, for example, 50% of the maximum physical capacity, a decision can be made about the implementation of actual capacity improvements.

Exemplary embodiments described herein may derive a required capacity value for the transport network load in a multi-service transport network in which different service types having different QoS and GoS parameters share the same physical resources. As opposed to existing methods that merely monitor traffic throughput, the exemplary process described herein may take into account and may guarantee the GoS and QoS requirements for each service type. The exemplary process described herein may permit comparison of the actual transport network load with the dimensioned (i.e., planned) capacities and the maximum physical capacities of the links, thereby enabling identification of capacity shortages before service degradation may be experienced. Historical required capacity data may be useful for planning network capacity updates in an optimal way before service degradation occurs.

Embodiments described herein provide illustration and description, but are not intended to be exhaustive or to limit the implementations to the precise form disclosed. Modifications and variations are possible in light of the above teachings, or may be acquired from practice of the implementations. For example, while series of blocks have been described with regard to FIGS. 5-7, the order of the blocks may be modified in other embodiments. Further, non-dependent blocks may be performed in parallel.

The exemplary embodiments, as described above, may be implemented in many different forms of software, firmware, and hardware in the implementations illustrated in the figures. The actual software code or specialized control hardware used to implement the exemplary embodiments described herein is not limiting of the invention. Thus, the operation and behavior of the exemplary embodiments were described without reference to the specific software code—it being understood that one would be able to design software and control hardware to implement the exemplary embodiments based on the description herein.

Furthermore, certain portions of the invention may be implemented as “logic” that performs one or more functions. This logic may include hardware, such as an application specific integrated circuit or field programmable gate array, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1-16. (canceled)

17. A method implemented in a network management node associated with a multi-service transport network, comprising:
obtaining dimensioned network parameters associated with an initial plan of the multi-service transport network;
measuring performance parameters associated with each service of a plurality of services of the multi-service transport network, wherein each service is associated with a different one of a plurality of traffic types;
estimating a transport capacity for the multi-service transport network based on the measured performance parameters, based on the obtained dimensioned network parameters, and based on Quality of Service, QoS, and Grade of Service, GoS, requirements associated with each of the different traffic types; and
providing the estimated transport capacity for network capacity planning.

18. The method of claim 17, wherein the plurality of traffic types include a best effort traffic type and a call admission controlled traffic type and share the same transport resources in the network.

19. The method of claim 17, wherein providing the estimated transport capacity comprises using the estimated transport capacity to predict a capacity shortage in the network.

20. The method of claim 17, wherein the performance parameters include a number of active Radio Access Bearers, RABs, in the multi-service transport network, a throughput value, and a call blocking value.

21. The method of claim 17, wherein estimating the transport capacity for the multi-service transport network comprises using a Kaufman-Roberts algorithm for estimating the transport capacity.

22. The method of claim 17, wherein the plurality of traffic types includes a Best Effort, BE, traffic type and a Call Admission Controlled, CAC'd, traffic type, and wherein the method further comprises:
determining a capacity associated with the BE traffic type; and
determining a capacity associated with the CAC'd traffic type,
wherein estimating the transport capacity further comprises estimating the transport capacity based on the capacities determined for the BE traffic type and the CAC'd traffic types.

23. The method of claim 22, wherein determining the capacity for the BE traffic type comprises determining that capacity based on the measured performance parameters and based on the obtained dimensioned network parameters.

24. The method of claim 23, further comprising determining an equivalent bandwidth for the CAC'd traffic type based on the dimensioned parameters or based on the measured performance parameters.

25. The method of claim 24, where determining the capacity for the CAC'd traffic type comprises determining that capacity based on the Grade of Service, GoS, requirements, the determined equivalent bandwidth for the CAC'd traffic type, and the measured performance parameters.

26. A network management device coupled to a multi-service transport network, comprising:
a network performance monitoring unit configured to monitor a number of active calls, throughput, and call blocking data associated with each service of a plurality of services serviced by the multi-service transport network, wherein each service is associated with a different one of a plurality of traffic types; and
a network capacity analyzer configured to:
estimate a transport capacity of the multi-service transport network, for use in network capacity planning, based on the number of active calls, the throughput, the call blocking data, and Quality of Service, QoS, and Grade of Service, GoS, requirements associated with each of the plurality of services; and
compare the estimated transport capacity with a pre-dimensioned transport capacity for a given link of the multi-service transport network.

27. The device of claim 26, where the network capacity analyzer is further configured to use the estimated transport capacity to predict a capacity shortage in the multi-service transport network.

28. The device of claim 26, where the network capacity analyzer is further configured to compare the estimated transport capacity with a maximum capacity for the given link of the multi-service transport network.

29. The device of claim 26, where the network capacity analyzer is further configured to compare the call blocking data with the Grade of Service, GoS, requirements for each Radio Access Bearer, RAB, in the multi-service transport network.

30. The device of claim 26, further comprising a results unit configured to display the estimated transport capacity in conjunction with other network capacity planning parameters.

31. The device of claim 30, where the other network capacity planning parameters include at least one of a dimensioned network capacity value associated with a design of the multi-service transport network, a maximum capacity of the given link, and call blocking data associated with calls in the multi-service transport network.

32. A computer program product stored on a computer-readable medium and comprising instructions that, when executed by at least one processing device associated with a network management node, cause the network management node to:
obtain dimensioned network parameters associated with an initial plan of a multi-service transport network;
initiate measurement of performance parameters associated with each service of the multi-service transport network, wherein each service is associated with a different one of a plurality of traffic types;
estimate a transport capacity for the multi-service transport network based on the measured performance parameters, based on the obtained dimensioned network parameters, and based on Quality of Service, QoS, and Grade of Service, GoS, requirements associated with each of the plurality of traffic types; and
provide the estimated transport capacity for network capacity planning.
